(19) United States
(12) Patent Application Publication
(10) Pub. No.: US 2012/0269185 A1
(43) Pub. Date: Oct. 25, 2012

(54) SYSTEM AND METHOD FOR COMPUTER BASED COLLABORATION INITIATED VIA A VOICE CALL

(75) Inventors: Mark CASTLEMAN, Austin, TX (US); Charles MILLER, Austin, TX (US)

(73) Assignee: PBX CENTRAL CORPOTATION, Austin, TX (US)

(21) Appl. No.: 13/089,440

(22) Filed: Apr. 19, 2011

(51) Int. Cl. H04L 12/66

(52) U.S. Cl. 370/352

(57) ABSTRACT

A method and infrastructure for online collaboration, cloud computing in which collaboration sessions, known as peering sessions, are triggered by telephone calls. Other systems and methods are disclosed.

### BACKGROUND OF THE INVENTION

The present invention relates generally to network-based computerized collaboration and more particularly to collaboration initiated and keyed from voice calls.

The Internet provides a rich repertoire of tools for communication, collaboration, and business activities. These tools include e-mail, Internet chat, real-time collaborative editing, web meetings and Voice over Internet Protocol telephony. The Internet also provides various forms of online social networking services such as Facebook¹, LinkedIn², salesforce,³ etc. Many of the tools provide for multiple modes of interaction, e.g., it is possible to create a web meeting session in which the participants view a common presentation in conjunction with voice communications. Similarly, several services exist in which two parties may engage in an exchange of video and audio communications simultaneously, e.g., using Skype⁴ video chat or video chat services on Apple's iChat⁵ product. ¹ of Facebook, Inc., Palo Alto, Calif.² of LinkedIn Corporation, Mountain View, Calif.³ of salesforce.com, inc., San Francisco, Calif.⁴ of Skype Limited, Luxembourg⁵ of Apple, Inc., Cupertino, Calif.

Many businesses have an online presence. For some businesses, the online business presence is their primary interface to customers, e.g., eBay.com⁶ and Amazon.com⁷. Other businesses have both brick-and-mortar facilities and a heavy reliance on online interfaces to their customers. Such businesses include banks, universities, and storefront retailers, for example. ⁶ of eBay Inc. San Jose, Calif.⁷ of Amazon.com. Inc., Seattle, Wash.

As is the case with in-person meetings, Internet collaboration often involves multiple forms of electronic media, very often including the combination of displayed visual media such as written materials and photographs plus voice communication carried over telecommunications networks. A simple example illustrates this point: Consider an interaction between a bank and one of its customers in which the customer requires an explanation of a transfer between two accounts. While the information concerning the transfer may be available over a Web site operated by the bank, a customer may not be able to find the information the customer seeks without the assistance of a support person at the bank.

Collaboration tools give geographically dispersed parties the ability to share documents, presentations, “white boards,” audio and other digital file stores through a computer interface usually interconnected to the other user or users through the Internet. In general, both parties agree in advance to “meet” at an Internet site where the parties will join a shared virtual meeting space in which they can communicate and/or exchange data. Some examples of these types of services include Webex⁸, NetMeeting⁹, and GoToMeeting¹⁰. ⁸ of WebEx Communications Inc., Santa Clara, Calif.⁹ of Microsoft Corporation, Redmond, Wash.¹⁰ of Citrix Systems, Inc, Santa Barbara, Calif.

In the current virtual meeting scenario, the participants generally agree in advance to a time and location (i.e., an Internet site address) where the parties will gather, login, authenticate, and begin “collaborating” by sharing documents, images, or other information found in presentations or videos. Another scenario frequently encountered in business and social environments is that Person A telephones Person B requesting that Person B reference a document obtained using Person B's computer access, e.g., “Hi Joe, glad you're there. Could you open next year's budget proposal that I just emailed you so we can discuss it now?” In other words, a scenario in which a telephone call is used to indicate verbally to the other party which electronic documents to review.

As is the case with many collaborative applications, Netmeeting enables two or more users to connect to a common environment or even directly so that information can be shared on each user's computer interface.

GoToMeeting is a Web-hosted service in which online attendees may view a desktop of a host computer. Using GoToMeeting the meeting host may share a screen view of the host computer or specified files thereby allowing meeting attendees to view either the screen view or such files. Through a VoIP channel provided by GoToMeeting, attendees may confer with the host and other GoToMeeting attendants.

Real-time collaborative editing (RTCE) is a technology in which several users may view and edit a shared online document simultaneously. Examples, of RTCE editors include ACE¹¹. Other examples may be found in Google Docs¹² and other similar services which allow shared authoring. These document authoring services and applications remain isolated from the collaborative environments in which engaging users in collaborative sessions is a procedural chore. ¹¹ from The ACE Project and SubEthaEdit from TheCodingMonkeys, Munchen, Germany¹² from Google Inc., of Mountain View, Calif.

Cloud computing forms yet another mechanism for online collaboration in which end-users do not know per se the physical location and configuration of servers on which programs, services, and data is located. Users interact with services, for example, using a web browser, as if the programs and data are installed locally. By allowing multiple users access to the same data installed in a cloud, users may collaborate. As with the email example given above, one person seeking to collaborate on a document in real-time may call another person using a telephone connection to alert that second person to access a document in the cloud for review, comment or edit.

Telephony has been a preferred mechanism for human interaction because of the primacy of spoken language and immediate response in inter-human communication. Voice communication provides immediacy that neither document sharing nor email nor text messaging has been able to achieve. For a high rate of information exchange in real-time, no printed-word-based technology is as efficient as voice-to-voice communication. Even in today's technologically advanced world, voice-to-voice communication has increased even though other modes of communication are available and in some ways competitive to voice conversation.

However, new technologies have broadened the meaning of telephone service. It is becoming increasingly common for telephone to be carried over the Internet in the form of Voice over Internet Protocol (VoIP) telephony and mobile telephony has reached extensive market penetration in the United States and many other countries. Nevertheless, the publicly switched telephone network (PSTN) remains a popular choice for connecting both homes and businesses to telephone service.

While there are multiple telephone technologies in use, these are co-existing and interoperable. For example, a user with a telephone connected through the PSTN may call a telephone connected to a VoIP service over the Internet and vice-versa. That call would be placed on a route that starts at the PSTN, connects through a gateway of the VoIP network, over the Internet, and finally connects to the destination at the destination's given IP address. Thus, the call may be placed even though the parties are connected to different networks, the PSTN and Internet, respectively.

A very common office setup is for an office worker is to have a VoIP telephone on the desk in conjunction with a desktop computer or a docking station for a notebook computer. When away from the office, the office worker is likely to rely on a mobile telephone, often a smart phone such as an iPhone¹³ or a Blackberry¹⁴, and may make use of the notebook computer for email, etc. The worker would primarily rely on the telephone for voice communications, yet often would be called upon to reference or collaborate on documents and other information accessed via the computers. ¹³ of Apple Inc., Cupertino, Calif.¹⁴ of Research In Motion Limited, Waterloo, Ontario, Canada

A similar situation occurs in the non-business use of the Internet as well. For example, a person may wish show some digital photographs to a friend while talking on the telephone. Typically that may require the photographer to email the photos to the friend, invite the friend to visit the photographer's online depository for photographs such as flickr¹⁵ or Photobucket,¹⁶ or invite the friend to an online meeting site such as GoToMeeting at which the photographer would show the photographs as a presentation. ¹⁵ of Yahoo!, Inc., Sunnyvale, Calif.¹⁶ of Photobucket Inc., Seattle, Wash.

From the foregoing discussion and in light of the many communication modes or models of sharing information, it is apparent that there is still a need for an improved method to provide a seamless linkage from the initiation of voice communications sessions to an online collaborative environment wherein participants in the sessions are automatically linked to collaboration tools and documents, thus allowing the participants to directly and effortlessly participate in an online collaboration upon the initiation of voice communication sessions.

### BRIEF DESCRIPTION OF THE DRAWINGS

FIG. 1 is a network diagram illustrating connections between various pieces of equipment in a networked system for allowing online collaboration linked to telephone calls.

FIG. 2 is an illustration of one example of a peering session.

FIG. 3 is a block diagram illustrating one embodiment of a network architecture for the peering cloud of FIGS. 1 and 2.

FIG. 4 is a network diagram illustrating a peering session executing concurrently with a telephone call and provides the high-level software architecture of two peering client computers.

FIG. 5 is an illustration of the user interface presented by a peering environment on a mobile telephone.

FIG. 6 is an illustration of an example notebook (or desktop) computer peering environment user interface.

FIG. 7 is a data base schema for one embodiment of the peering database of FIG. 3.

FIG. 8 is an illustration of the database of FIG. 7 with example values in several of the relations.

FIG. 9 is a timing sequence diagram illustrating message flow and operations associated with the creation of a peering session from a telephone call being placed between two users.

FIG. 10 contains several timing sequence diagrams illustrating exemplary data flows for performing certain actions of the peering cloud.

FIG. 11 is a data flow and timing sequence diagram illustrating an intervening peering session of a third user onto an existing peering session between two users.

FIG. 12 is an illustration of the software installed on a smart phone including a peering cloud client application.

FIG. 13 is a timing sequence diagram illustrating the local detection of a peering relationship and initiation of a peering session on an intelligent telephone, e.g., a smart phone, an IP phone or computer executing a VoIP client.

FIG. 14 is a block diagram of a peering session similar to the peering session illustrated in FIG. 2 in which the voice session is used to create context-relevant information related to the voice conversation in the voice session for display in the peering environment of at least one of the parties to the voice session and associated peering session.

FIG. 15 is a timing sequence diagram illustrating one example of use of a topic of a telephone conversation linked to a peering session to determine and display topic-relevant information in the peering environment of at least one of the users who is a party to the telephone conversation and the peering session.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Much of the technology described herein is concerned with the execution of particular pieces of software on corresponding hardware devices, e.g., a server program may be executing on a server computer. To facilitate the narrative, we may state that such a program performs an action. Such statements should be read as shorthand for stating that the corresponding hardware device performs the action by executing the instructions of the named program. Conversely, we may also state that a hardware device performs a particular action that has been programmed with a particular computer program. That should be taken to mean that the hardware device executes instructions of that computer program to perform the action. There is virtually no limit in how pieces of computer equipment may be programmed and arranged for performing certain tasks. Thus, any specific hardware configuration or computer software design or architecture described herein should only be considered as an example embodiment.

In an embodiment of the invention, a system and method for online collaboration triggered from the initiation of a telephone call is described. That collaboration technology provides a seamless, quick, efficient, immediate and automatic mechanism for two or more parties to collaborate with one another over a computer network in conjunction with the placement of a voice telephone call.

A collaboration method in which at least a first party and a second party collaborate over a voice telecommunications link and a computer network communications link may commence with the receiving a call initiation from the first party indicating a desire to place a call to the second party. The method may proceed with the step of determining whether the first party has a peering relationship with the second party. If the first party has a peering relationship with the second party, a peering session is started between the first and second party. Starting the peering session includes determining the peering relationship parameters of the peering relationship between the first and second party. Peering environment on a first peering device operated by the first party is launched (unless already executing) and a peering environment on a second peering device operated by the second party is also launched (unless already executing). The peering environments may be structured based on the determined relationship parameters or default parameters. A communications link between the first and second peering environments is established as well as a voice communications session between the first party and the second party. A peering relationship may be further defined by the applications from which the first and second party share data. These user applications include at least one application selected from social network applications, photo applications, word processing applications, contact management applications, and storage of electronic files including word processing files, audio files, application programs, smart phone apps, video files, data records, data storage.

The collaboration method described may be executed on an infrastructure which may be referred to as a peering cloud and which includes one or more server computers connected over a computer network, e.g., a cloud computing network, that preferably may be located on the Internet, and which in are connected or to which connections may be established with peering devices, e.g., computers, of the first and second parties.

The peering cloud may receive a call creation message from the telephone network to a peering environment server (part of the peering cloud infrastructure) including identifying information for the first party, corresponding to the caller, and the second party, corresponding to the callee, corresponding to the call initiation. The telephone network may be any combination of PSTN, VoIP, mobile telephony, or other telephone networks. Alternatively, the call creation message may be created by an intelligent calling device (including a networked computer executing a telephone client or a smart phone) which detects the operation of the telephone to place a telephone call. The calling device then transmits the call creation message to the peering environment server.

The determination of whether a peering relationship exists may include querying a peering database that is part of the peering cloud.

The collaboration method, for example, embodied by the programming of a corresponding peering cloud infrastructure, may further include receiving a peering registration request by a first user operating the first peering device and upon receiving the peering registration from the first peering device, creating a peering profile for the first user wherein the peering profile defines at least one characteristic of the user. That characteristic may include one or more of location, relationship status, presence, notification of activity, communication preference, client device type, date and time of client location, client system ability or characteristics.

In one embodiment, the peering cloud infrastructure maintains records of peering sessions so as to enable determination of data items shared between the first and second user during prior peering sessions and displaying pointers to such shared items in a collaboration dashboard on the first and second peering environments.

The peering cloud infrastructure may further include mechanisms by which the peering cloud infrastructure may be operated to include third party in peering sessions, for example, by notifying the third party that a peering session is being initiated between the first and second party. Thus, the collaboration method may further include allowing the third party to join the peering session by creating a voice communications session between the third party and the voice communications session between the first and second party and joining the third party to the peering session between the first and second party by initiating a third peering environment on a third peering device operated by the third party and initiating a communications link between the third peering device and the third, first and second peering environments.

The collaboration method may further include parsing the voice communications session, determining a topic related to the voice communications session from the parsed voice communications session, retrieving data relevant to the determined topic related to the voice communications session, and displaying the retrieved data relevant to the determined topic in at least one of the peering environments.

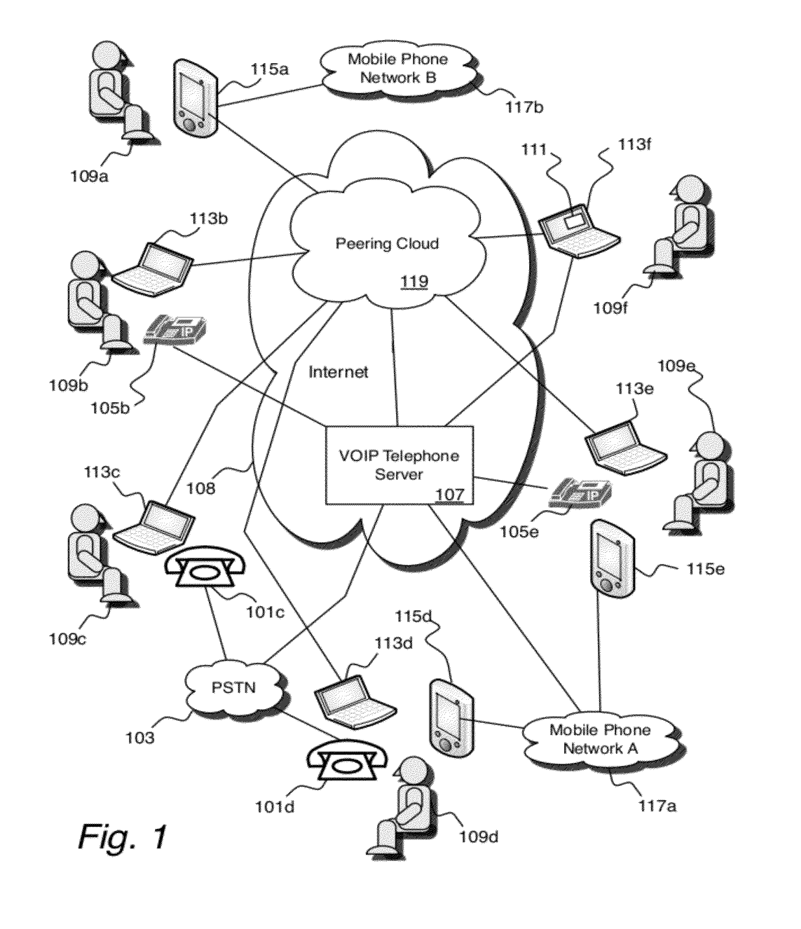

FIG. 1 is a network diagram illustrating connections between various pieces of equipment in a networked system for allowing online collaboration linked to telephone calls. There are four types of telephones illustrated in FIG. 1. Traditional telephone sets 101¹⁷ connected to the PSTN 103, Internet Protocol (IP) telephones 105 connected to a VoIP server 107 over the Internet 108, VoIP clients 111 operating on host computers 113. While FIG. 1 only shows one VoIP server 107, the reality is that there are many providers of VoIP services and each such provider could operate one or more servers 107. Finally, mobile telephones 115 may be used to connect to the telephone networks via a mobile telephone network 117 connected in some fashion to the VoIP server 107. Of course, there are other telephones and telephone networks that are not illustrated but that may be used for placing phone calls in the context of FIG. 1, e.g., satellite or ship-to-shore. A user 109 may place a call to any telephone (PSTN, IP phone, mobile phone or other phone) associated with another user 109 provided that the various telephone networks provide a mechanism for such a connection. ¹⁷ In this document, pieces of equipment or components thereof of a like kind are given a common reference numeral. Each individual is provided a letter suffix. Thus, telephones 101c and 101d are essentially the same type of telephone—here their common feature is that they connect to the PSTN. Furthermore, because several pieces of equipment may be associated with the same user, each such piece of equipment given the same suffix. Thus, IP telephone 105b and computer 113b are both associated with user 109b, and so on. When reference is made solely using the numerical portion, the accompanying description should be taken to refer to all members of the set of elements bearing that numerical reference numeral.

Most individuals also have one or more access methods for accessing computerized networks, e.g., the Internet. FIG. 1 illustrates two such primary mechanisms via the use of notebook computers 113 or smart phones 115. While computers are illustrated herein as notebook computers, of course, the technology described herein is equally applicable to desktop computers, tablet computers, work stations, etc. The only requirement is that the computer is somehow connected to a computer network, e.g., the Internet 109.

Each of computers 113b, 113c, and 113f, and smart phone 115a is connected to a Peering Cloud 119. The Peering Cloud 119 is described in greater detail below. The Peering Cloud 119 is also connected to the VoIP Telephone Server 107. At a high-level, when it is detected (e.g., by the VoIP Telephone Server 107) that a telephone call is being placed between a first and a second user, the Peering Cloud 119 is notified of that call and determines whether the first and second user have a peering relationship. Herein a peering relationship is a relationship within which two or more entities, for example, persons, agree to exchange data traffic between or among them, as limited by a defined personal connection or membership in a group and within predetermined access parameters and wherein the parties to the peering relationship may collaborate over a peering session executing in parallel with a telephone call. Upon the attempt at placing the telephone call, a peering session is to be established automatically between the defined computers associated with the first and second users who have a peering relationship.

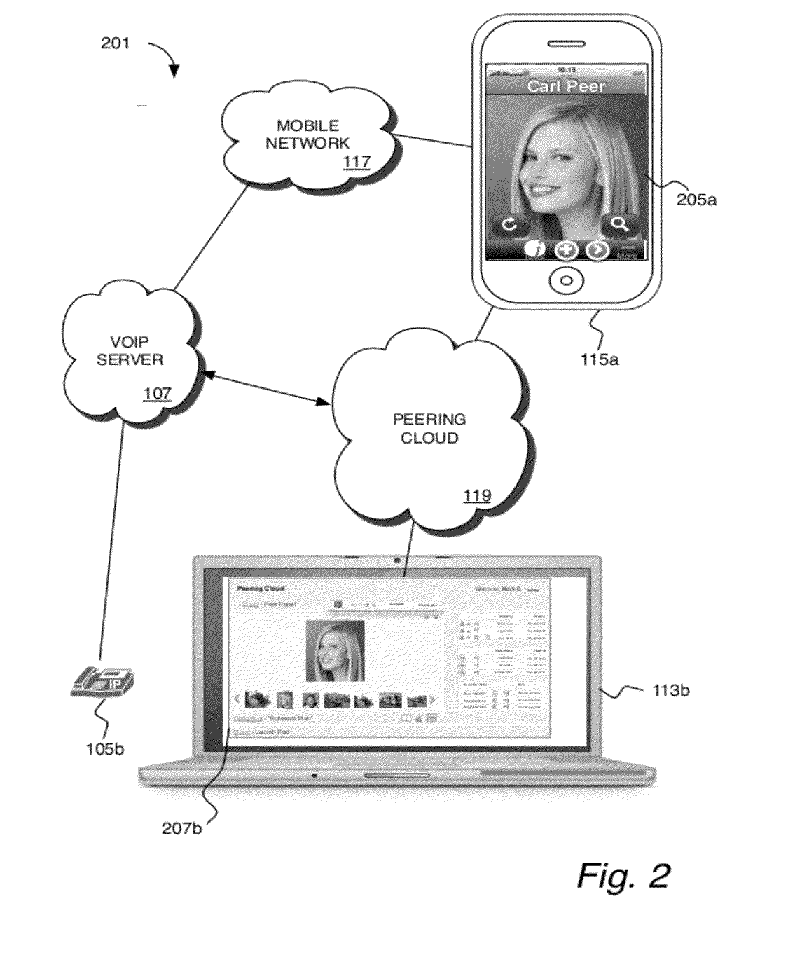

Peering sessions may take many forms. FIG. 2 is an illustration of one example of a peering session 201. A User A, using a mobile telephone 115a, places a telephone call to IP telephone 105b of a User B. The telephone call goes via the mobile network 117 to the VoIP server 107. The VoIP server 107 transmits an indication of the call, including caller (e.g., User A's caller ID (CID)) and callee (e.g., User B's CID), to the Peering Cloud 119. The Peering Cloud 119 determines that User A and User B have a peering relationship. The Peering Cloud transmits a peering session start message to the currently-registered computers of User A and User B, respectively. In the case of User A, the currently-registered computer is the same smart phone 115a that the initial call was placed on. For User B, the currently-registered computer is notebook computer 113b. The peering session start message from the Peering Cloud 119 to a particular user, e.g, User B, may be transmitted to multiple computers registered with that particular user and the user may select one or more of those computers for the peering session. Typically, however, a user would only have one active computer for peering purposes.

The peering session start message is directed to a peering client executing on the two peering devices (the smart phone 115a and the notebook computer 113b), respectively. A peering client is a computer program executing on a peering device and containing instructions for the peering device to create a collaborative environment, herein a peering environment, through which the peering users may share documents etc. In one embodiment, the users of these devices, respectively, may be given the option to start a peering session corresponding to the telephone call, or to start the peering session automatically may be a preset default action depending on a preference setting of the users.

The peering clients on each peering device display a peering environment user interface 205 and 207 on the display units of the peering devices, respectively.

Due to the different natures of peering devices, e.g., desktop computers or mobile phones, the peering environments may be markedly different to the specific capabilities of the corresponding display device. For example, the peering environment 207 for a notebook computer 113 is usually more feature rich than the peering environment 205 of the mobile telephone 115. The peering environments are discussed in greater detail herein below.

Through the peering environments, the users A and B may conduct an online collaboration in conjunction with the telephone call initiated by User A. The peering cloud determines the parameters of the peering session between these two users. The peering history of the two users may, for example, be used to determine that when users A and B collaborate through a peering session, they view User B's photographs. The peering session, as a consequence of that peering history, may default to displaying photographs from User B's photo library. As User B selects a particular photograph in the peering environment, e.g., to show a photograph of an actress considered for a role in User A's motion picture project, a message that the photograph has been selected is transmitted from the peering client on User B's computer 113b to the peering cloud 119 which in turn transmits the photograph to peering client for display in the peering environment 205a of User A's mobile telephone 115a.

Thus, upon the initiation of a telephone call over a telephone network from User A to User B, a peering session is automatically created using the peering cloud 119 to allow users A and B to collaborate using assets found on their respective computers 113b and 115a.

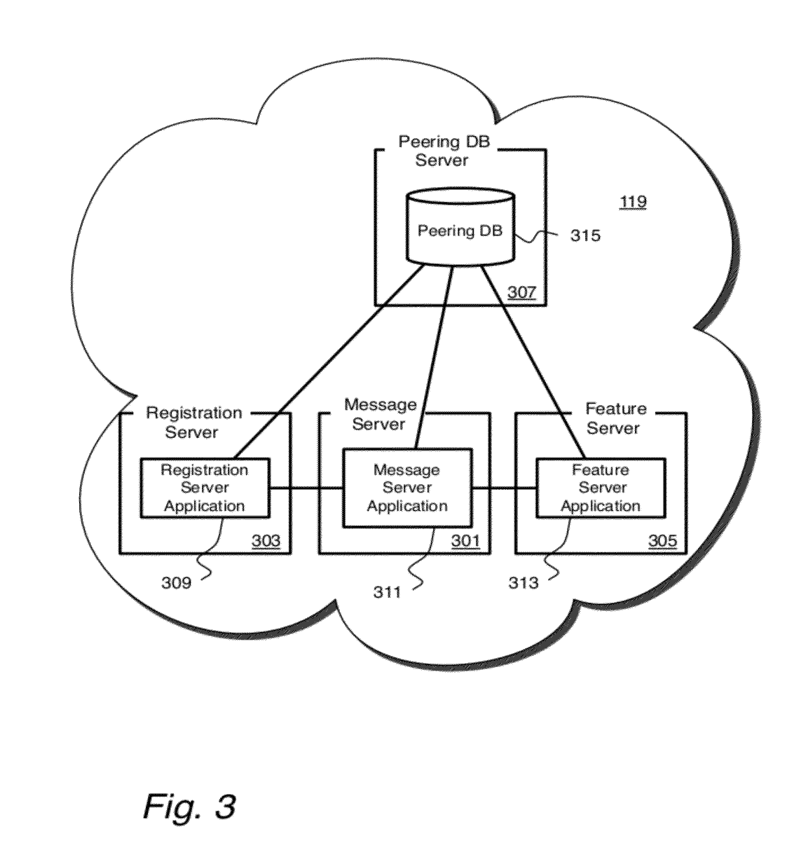

Turning now to the details of the peering cloud 119. In one embodiment, the peering cloud 119 is configured as a set of servers, each server being dedicated to one or more specific tasks performed by the peering cloud 119. FIG. 3 is a schematic illustration of one such embodiment in which the peering cloud 119 is divided into a message server 301, a registration server 303, a feature server 305, and a peering database server 307. In other embodiments, the peering cloud 119 may be constructed as a collection of programs executing on one computer. In yet another embodiment, the peering cloud 119 executes on multiple computers in which the registration server 303, the message server 301, the feature server 305, and the peering DB server 307 are distributed over several machines. In yet another embodiment, the peering cloud 119 is implemented as multiple peering clouds that cooperate with each other to manage peering sessions by transmitting peering messages between each other.

In the example of FIG. 3, the message server 301, a registration server 303, a feature server 305, and a peering database server 307 each execute particular software programs to perform their designated functions. Thus, for example, the registration server 303 is programmed with a registration server application 309, the message server 301 is programmed with a message server application 311, and the feature server 305 is programmed with a feature server application 313. The peering DB server 307 is a database management system server programmed with a database for storing the peering data, the peering DB 315.

In the embodiment of FIG. 3, the registration server 303 performs the following functions:
Authentication—Authentication is the procedure by which the Peering Cloud 119 determines the identity of the registrant, e.g., using userIDs, passcodes or keys.
Authorization—Once a user is authenticated, the user is then known and may now be authorized to access a variety of peer capable applications, data stores, networks, etc., depending on the specific privileges of the user.
Resource allocation—e.g., allocation of peering sessions to pending peering requests. Resource management in the peering cloud is assessed by each of the servers who participate in producing the collective capability of the peering cloud. A resource is generally an arbitrary definition measuring the capacity of the peering cloud or its participating server(s). Each server delivers a part of the overall capability and therefore the servers that make up the peering cloud 119 each assess their respective available resources or these resources are assessed by other servers. For example, a collection of servers constituting a peering cloud may measure its collective resource capacity to handle, for example, one thousand users. As resources are consumed, however, that assessment may change and require subsequent registrants to find another registration server on the network. The resource allocation function of the registration server 303 may operate to acquire or release cloud resources available on a cloud computing service hosting the peering cloud 119.
Presence service—i.e., maintaining a presence state of the various registered peering users to indicate whether a particular user is available for peering, etc. Presence state is essential to peering because maintaining presence state enables disconnected devices to connect or to locate one another by way of an immobile third party also known as the presence server. The presence server maintains location status, network status and information on all of the users who share presence information with the server. Presence information can be very simple, e.g., merely an IP address, or more complicated, e.g., a dataset which could, in the case of a vehicle, include GPS location, speed, direction, temperature, mileage, etc.

The peering message server 301 is a message exchanger between the registration server 303, the feature server 305, and the peering DB 315. The peering message server 301 further receives and transmits messages between the peering cloud 119 and the client applications executing on user peering devices. The peering message server 301 performs the following functions:
Status—The message server monitors the peering cloud 119 components, e.g., the registration server 303, feature server 305 and connected peering user devices, e.g., computers 113 and portable devices 115, for changes in the presence state or status. The message server 301 works on keeping all of the other components informed by transmitting messages between the various components or devices. The messages may contain simple information or even directives to complicated binary payloads which are interpreted by the client applications in the peering cloud application environment.
Notification—Notification is a part of the message server functionality. Within a complex system of isolated or disconnected parts operating as a whole, a notifier sends information to other parts of the system. A notification system does not ask for anything, it only relates events. In the case of the peering cloud, servers, devices, apps and clients are in constant receipt of notification events which describe other activities occurring on the network with other clients or in the peering cloud server architecture. One registration server may notify the feature server, by way of the message server, that the registrant has lost registration and should not receive further communication with the feature server until registration is established once again.

The feature server 305 performs the following functions:
Service delivery for hosted/cloud managed applications, e.g., retrieving data from the peering DB for transmission to peering clients executing on peering user devices.
Peering cloud manager for client-based applications, e.g., acts as an interface between the peering cloud 119 and client based apps. For example, a social networking app such as Facebook may be an application which two peering users use during a peering session. To provide peering cloud peering in Facebook, a Facebook user subscribes to a Peering Cloud app for Facebook. The peering cloud feature server 305 provides interfacing between the Peering Cloud Facebook App and the Peering Cloud Message Server 301. In this way, the Peering Cloud feature server is able to act as a proxy to the information each user has stored in their corresponding Facebook accounts.
Back-to-back User Agent (B2BUA)—as a B2BUA for a peering session the feature server 305 operates between the two end points of a peering session to mediate signaling between the two end points. The feature server 305 maintains complete presence state between the two end points and hides network internals (e.g., local network addresses, network topology).

The peering cloud DB 315 is described in greater detail below. The Peering Cloud DB 315 describes relationships between various peering users, the data elements peering users share, etc.

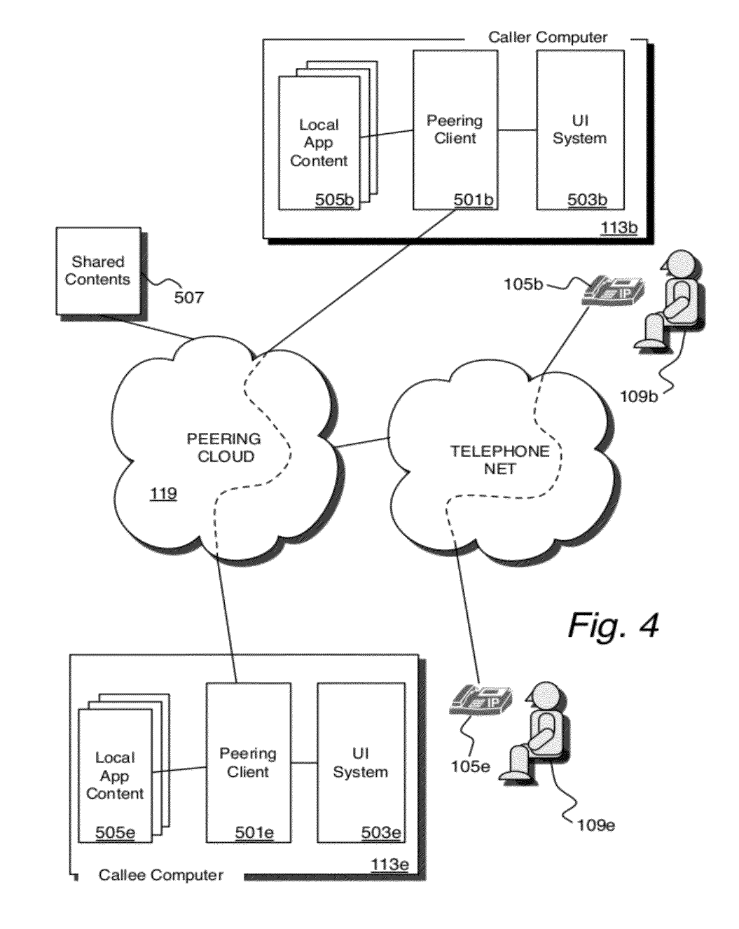

FIG. 4 is a network diagram illustrating a peering session executing concurrently with a telephone call and provides high-level software architecture of two peering client computers 113. Each of the peering client computers 113 contains a peering client 501. The peering client 501 manages message flow on the client side of the message exchange with the peering cloud 119. The peering client 501 further interacts with the user interface system 503 of each client computer 113 for user interaction operations with users 109 through display and input devices. In one embodiment, the peering client 501 executes as a Web application on a Web browser, such as Mozilla Firefox or Apple's Safari. The peering clients 501 may further interface to locally stored content 505, e.g., locally stored photographs or word processing documents, on each of the peering computers 113.

The peering cloud 119 may be connected to shared content 507, i.e., documents stored in the cloud, and served to the peering clients 501.

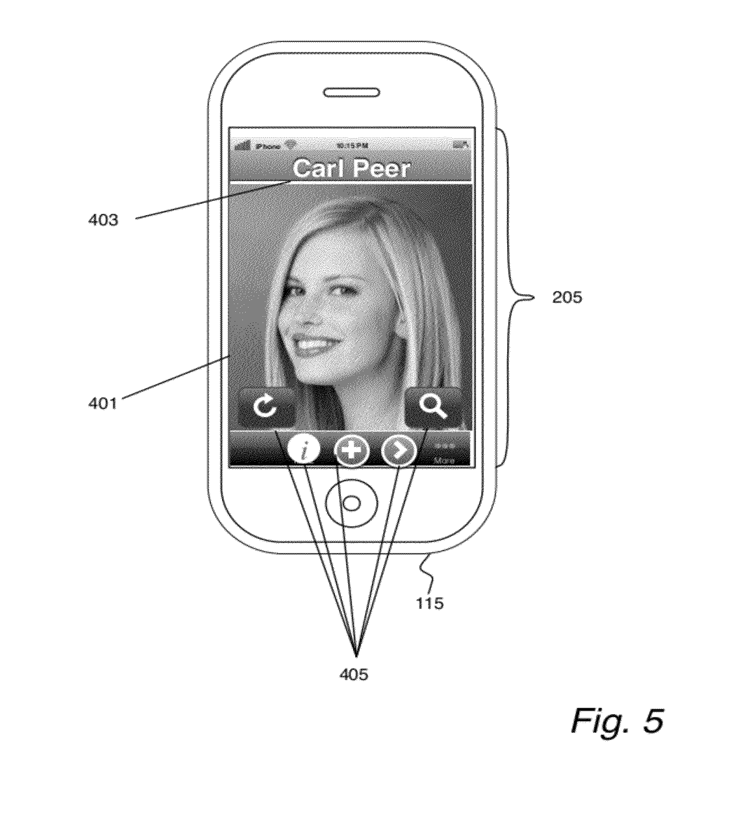

Turning now to detailed examples of the peering environments displayed on peering devices: FIG. 5 is an illustration of the user interface presented by a peering environment 205 on a mobile telephone 115.

The user interface includes a collaboration pane 401 in which a current collaboration data element is displayed. In the present example, the collaboration data element is a photograph. However, the underlying peering application could be a word processing program in which the data element would be a word processing document. Another example of a peering data element is a shared desktop view, in which the sharing pane would display a portion of the other peer's desktop. Other examples include data associated with specific underlying application programs, Web pages, icons for sound files and control of playback thereof, or views into social networking pages associated with the peer.

Generally speaking the peering users share a view of a data element, e.g., a photograph or a document, displayed through the collaboration pane 401.

The mobile phone peering environment user interface 205 further includes an identification pane 403 providing information relevant to the other peer that is a party to the peering session, e.g., that person's name (herein below the term distal peer is used to identify the peer at the opposite end of a peering session). The user interface 205 may also include control buttons 405 which allow functions such as “advance to the next data item,” “refresh,” “obtain information,” “zoom-in” or “perform a search.”

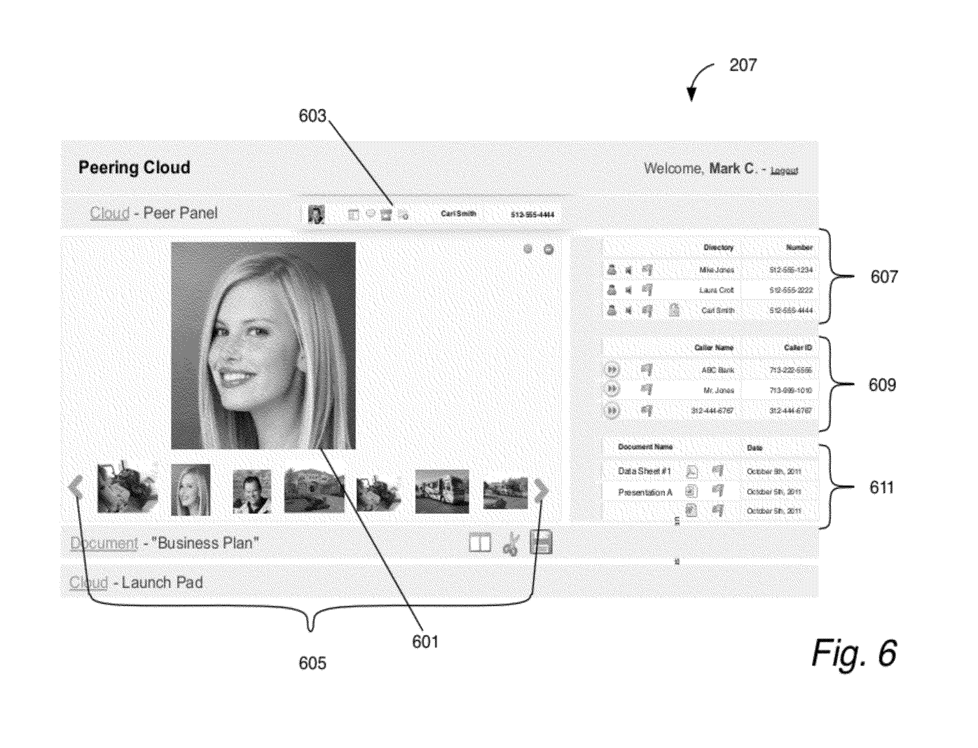

FIG. 6 is an illustration of an example notebook (or desktop) computer peering environment user interface 207. As with the mobile phone peering environment user interface 205, the notebook computer peering environment user interface 207 includes a collaboration pane 601 that provides a shared view of a data element and a peer toolbar 603. The peer toolbar 603 identifies the distal peer and provides user interface icons for peering tools related to the other peer, e.g., file transfer, chat.

The user interface 207 further may include a thumbnail list 605 containing available data elements and corresponding scroll arrows. By selecting another thumbnail in the thumbnail list, that corresponding data element is transferred to the collaboration pane 601 and a corresponding message is sent to the message server 301, which is forwarded to the peering client of the other peer.

The user interface 207 also includes a directory of peers 607 of the peering user. Peers may be defined by group memberships. For example, a user may be a member of a peering group established, for example, for a group of colleagues working on a common project, members of a family, a group of friends, or a two-person group with just two peers. These relationships are stored in the peering DB 315 and retrieved upon start-up of the peering client. The peering DB 315 displays the presence status of the user's peers and may include icons associated with tools related to peers, e.g., editing contact information, initiating a chat session, or initiating a telephone call and associated peering session.

The user interface 207 also includes a call-history pane 609 which is a list of previous peering sessions. The call-history pane 609 may include icons associated with tools related to previous calls such as call-back.

The peering cloud 119 maintains a record of data elements that have been used in previous peering sessions. These records are maintained in the peering DB 315 and are displayed in a peering data elements history pane 611. The peering data elements history pane 611 includes indication of file-type, date-and-time stamp for when accessed, etc. A user 109 may use the peering data elements history pane 611 for obtaining direct access to these documents. Typically, during an ongoing peering session, the peering data elements history pane 611 lists data elements that have been shared previously with the peers that are part of that ongoing peering session.

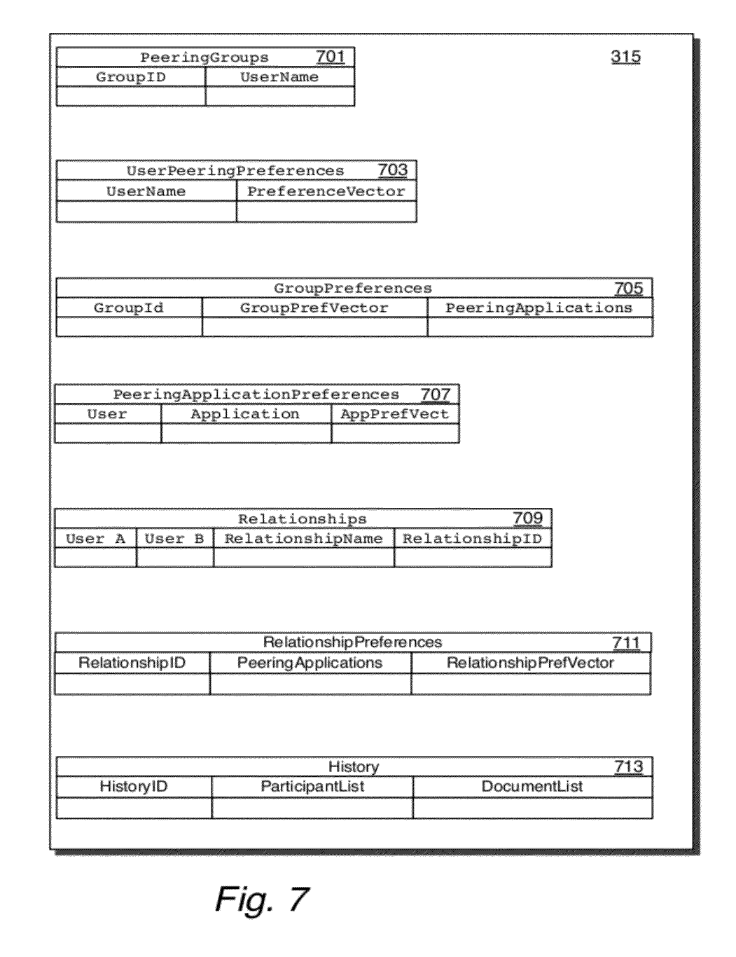

Turning now to the peering DB 315. In one embodiment the peering DB 315 is organized as a relational database and may follow a schema including the relations illustrated in the database schema of FIG. 7.

A PeeringGroups relation 701 defines the members of various peering groups. It may include the fields:
GroupID—The GroupID field is an identifying key for each peering group.
UserName—for each tuple the UserName defines a user member of a group defined by the GroupID field.

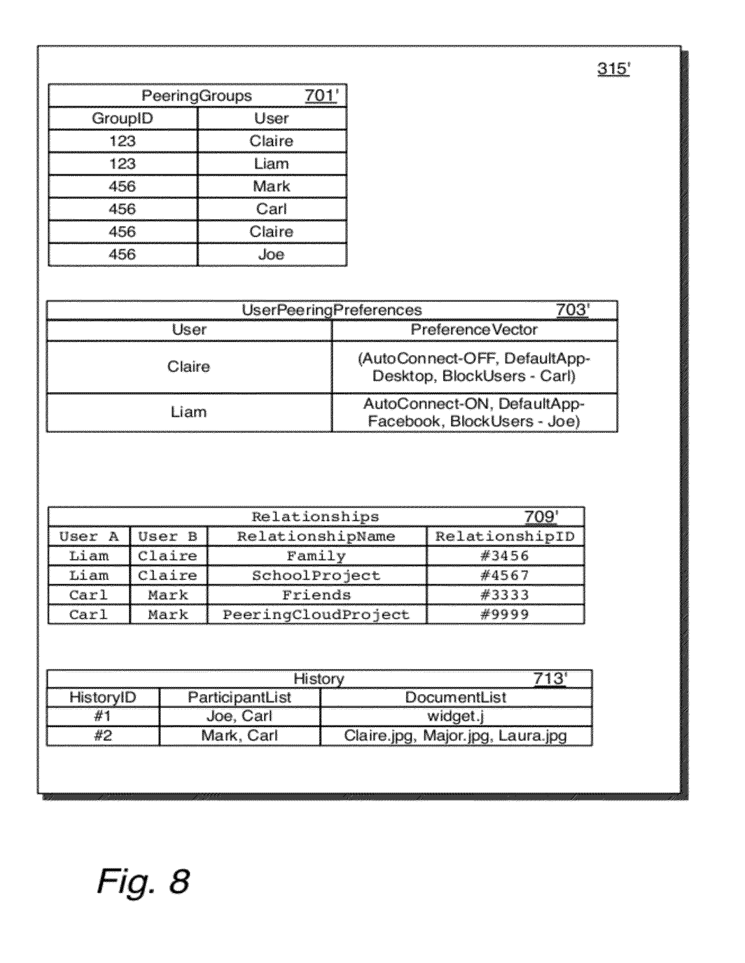

An example of the PeeringGroups relation 701′ is illustrated in FIG. 8. In the example PeeringGroups relation 701′ two groups are displayed, with Group 123 having the group members Claire and Liam and Group 456 having the group members Mark, Carl, Claire, and Joe.

One use of the PeeringGroups relation is to notify group members whenever a peering session is taking place. For example, if Mark and Carl (members of group 456) start a peering session, Claire and Joe may be notified. Similarly, if Joe logs into the peering cloud 119 after the peering session between Mark and Carl has concluded, Joe may be informed of the prior peering session between Mark and Carl and of any data items which Mark and Carl shared during that peering session. Thus, if group 456 is formed around a development team, and Mark and Carl had collaborated on a file such as a computer program, Joe may want to be informed of their work.

Each user may have certain preference settings for the user's peering relationships. Such preferences include whether a peering session is automatically created, whether User Approval is required to start a peering session, or whether warning messages are displayed prior to engaging in certain activities, e.g., screen sharing. The UserPeeringPreferences relation 703 of FIG. 7 is used to store user peering preferences, such as those displayed in the more fully realized relation 703′ of FIG. 8.

One embodiment for organizing peering preferences is in the form of a preference vector in which each element is a preference setting for a corresponding preference value. The preference vector is stored in the PreferenceVector field.

Peering groups may also have certain preference settings which are stored in the GroupPreferences relation 705 which includes the fields:
GroupId—key defining the group
GroupPrefVector—contains values for group-wide preference settings, e.g., default peering application for the group
PeeringApplications—Particular applications may be associated with each group. For example, a particular peering group defined for a product development team may share data elements from a code management system, a programming environment and from a documentation application. In another example, a group dedicated to managing social acquaintances may share a photo library application and a social networking application.

A particular user may have specific preferences associated with particular peering applications. These preferences are stored in the PeeringApplicationPreferences relation 707.

There may also be peering relationships identified between two users. Such relationships are defined in the Relationships relation 709. Because two users may have multiple peering relationships, e.g., a social relationship and a professional relationship, each relationship between two users may be defined by a relationship name stored in the RelationshipName field. Furthermore, each such relationship may have associated certain applications that the two users share during peering sessions and particular preferences for their way of collaborating over the peering cloud 119. These are stored in the PeeringApplications and RelationshipPrefVector fields, respectively, illustrated herein as being in a separate relation 711.

The peering cloud 119 maintains a record of peering sessions. These may be stored in a History relation 713. Each session is provided an ID, HistoryID and lists the participants in the peering session associated therewith in the ParticipantList field. The History relation 713 also stores the list of elements shared during the session in the DocumentList field. The History relation 713 may also store other details in regard to a session, e.g., date, time, and duration.

Naturally, in actual implementations of a peering cloud 119 other data particular to such implementations may be stored in the peering database 315.

FIG. 8 is an illustration of the database 315′ with several of the relations illustrated in FIG. 7 populated with example values.

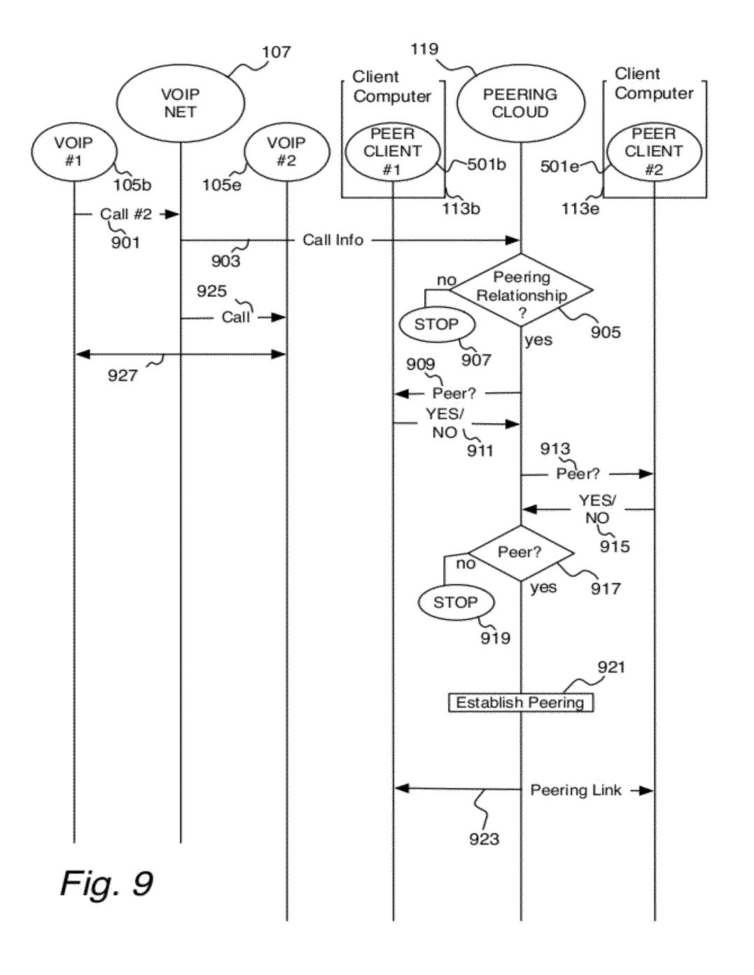

Turning now to the operation of the peering cloud 119. FIG. 9 is a timing sequence diagram illustrating message flow and operations associated with the creation of a peering session from a telephone call being placed between two users. In the example of FIG. 9, the telephone call is placed between a first IP telephone 105b and a second IP telephone 105e.

A first user 109b places a call to a second user 109e from the first IP telephone 105b to the second IP telephone 105e via the VoIP server 107, step 901.

The VoIP server 107 forwards information about the call, including caller and callee CIDs to the peering cloud 119, step 903. The VoIP server 107 further places the telephone call to the second user operating second IP telephone 105e, step 925, and telephone link is established between the two telephones 105b and 105e, step 927.

The peering cloud 119 determines, by accessing the PeeringGroups relation 701, whether there is a peering relationship between the first user 109b and the second user 109e, step 905. The “no” branch from the determination of a peering relationship existence typically merely terminates the process, step 907. Alternatively, the “no” branch could cause an invitation to start a peering relationship.

If there is a peering relationship between the first user 109b and the second user 109e, the actions that follow may depend on preference settings. For example, a peering session may be automatically created or, as is shown in FIG. 9, the peering cloud 119 may ask the first user 109b whether to start a peering session with the second user 109e by transmitting a message to that effect to the peering client 501b executing on the first user's computer 113b, step 909, and a corresponding dialog box is displayed on the first user's computer 113b allowing the user to respond. The first user 109b responds to the query and the response is transmitted back from the first computer peering client 501b to the peering cloud 119, step 911.

Presuming here, for the purposes of the example, that the first user 109b agreed to starting the peering session, a similar dialog is exchanged with the second user, steps 913 and 915.

If both parties have agreed to starting the peering session, step 917, a peering session is established, step 921, resulting in a peering session 923 connecting the two peering clients 501b and 501e executing on client computers 113b and 113e, respectively. Without agreement from both parties, through default values or dialog, the process stops, step 919.

To maintain an active peering session between the first peering client 501b and the second peering client 501e, each connected peering client 501 maintains connection to peering partners (i.e., other peering clients 501 operating on other users' peering devices via the back-to-back-user-agent services (B2BUA) of the peering cloud 119. In one embodiment, the B2BUA services are executed on the feature server 305. B2BUA services are services that cause an intermediary device, e.g., the feature server 305, to act like each of the devices at either end of a connection, i.e., the near-end peering client thinks the B2BUA service of the feature server 305 is the far-end peering client and vice versa. The B2BUA maintains the contact with each peering client. The use of B2BUA services are useful when determining network locations for devices resident on separated network structures whose internals are unknown to other networks.

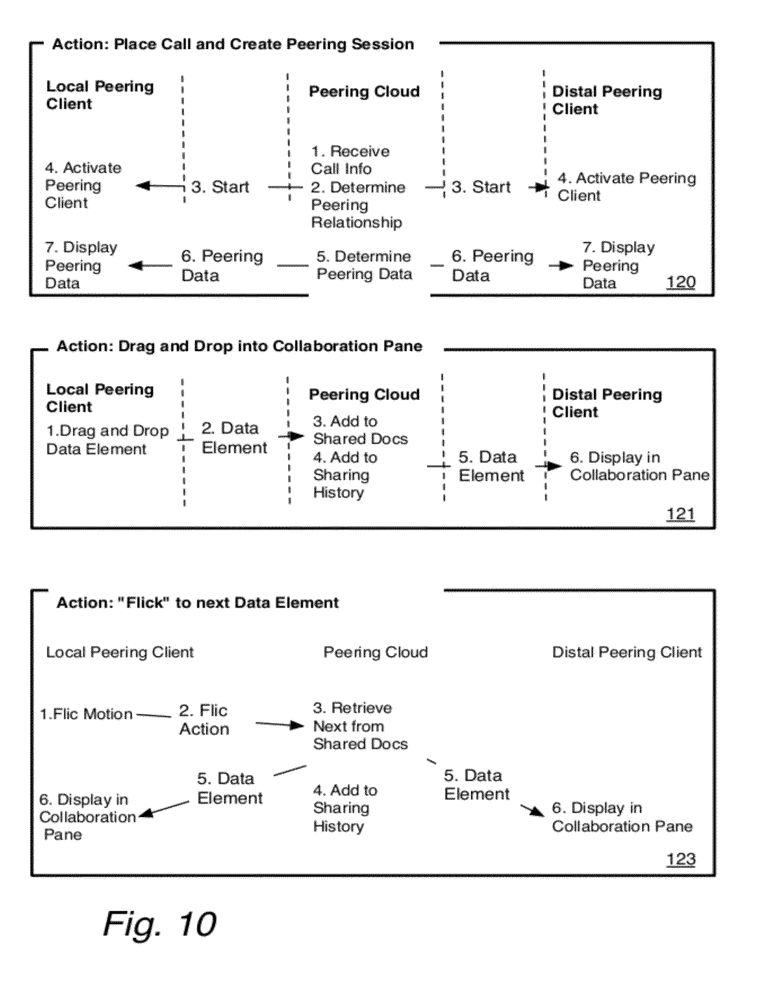

FIG. 10 contains several timing sequence diagrams illustrating exemplary data flows for performing certain actions of the peering cloud 119.

A peering session is created by the Place Call and Create Peering Session action illustrated by the timing sequence diagram 120. The Place Call and Create Peering Session action includes the following steps:
1. The peering cloud 119 receives the call info message from the telephone network, e.g., from the VoIP server 107.
2. The peering cloud 119 determines whether a peering relationship exists between the parties to the call. Note: as discussed herein below, the determination that a peering relationship exists may be performed locally, for example, by the peering client executing on a smart phone.
3. If a peering relationship exists, Start-Peering messages are transmitted by the peering cloud 119 to each of the peering clients corresponding to the parties of the telephone call.
4. Upon receiving the Start-Peering messages, each of the local and distal peering devices activates its respective peering client.
5. The peering cloud 119 determines the initial peering data to be shared, e.g., from preference settings or past peering history between the parties.
6. The initial peering data is transmitted to each peering client.
7. The peering clients display the peering data on each of the local and distal peering devices, thereby allowing the users operating the local and distal peering devices to collaborate on shared data.

The drag-and-drop of a data element action, e.g., file, onto the collaboration pane 601 is illustrated in timing sequence diagram 121. The drag-and-drop of a data element action includes the following steps:
1. A first user 109 drags and drops a data element onto the collaboration pane.
2. The data element is transmitted to the peering cloud unless the data element is already present in shared contents repository 507.
3. The data element, now being part of a peering session, is added to the shared documents depository for future access. Alternatively, the data element is a local element that is only stored on the peering devices, i.e., the local peering computer and the distal peering computer.
4. The data element is stored in the sharing history database so that in future peering sessions with the same peers the data element may be easily accessed or so that other members of the peering group can see which data elements have been used in collaborations within the peering group.
5. The data element is transmitted to the distal peering client.
6. The distal peering client displays the data element in the collaboration pane of the distal peering client.

Thus, by dragging and dropping the data element into the collaboration pane, the user at the local peering client has shared the data element with the user at the distal peering client.

A method to advance through a list of data elements, e.g., photos in a photo library, is to flick through the data elements by quickly dragging a finger across a touch sensitive display device on which the data element is displayed. This type of action is, for example, used on the Apple Inc. iPhone to advance to a next photograph when viewing photographs or to advance to a next album in the iPod application. A similar action may be used on a peering client app that has a touch sensitive display device.

Timing sequence diagram 123 illustrates the operations of the peering cloud associated with flicking through a list of data elements. It includes the following steps:
1. Flic motion: a user performs a flick motion across a displayed data element on the collaboration pane.
2. The flic action notification is transmitted to the peering cloud.
3. The peering cloud determines the “next” or “previous” data element (new data element) depending on the direction of the flick motion and retrieves the corresponding next or previous data element from the shared documents depository. Alternatively: if the new data element is a locally stored element which has not been uploaded to the shared documents depository, the new data element is transmitted (not shown).
4. The peering cloud adds the new data element to the sharing history.
5. The new data element is transmitted back to the local peering client (unless already available locally) and to the distal peering client.
6. The local and distal peering clients display the new data element.

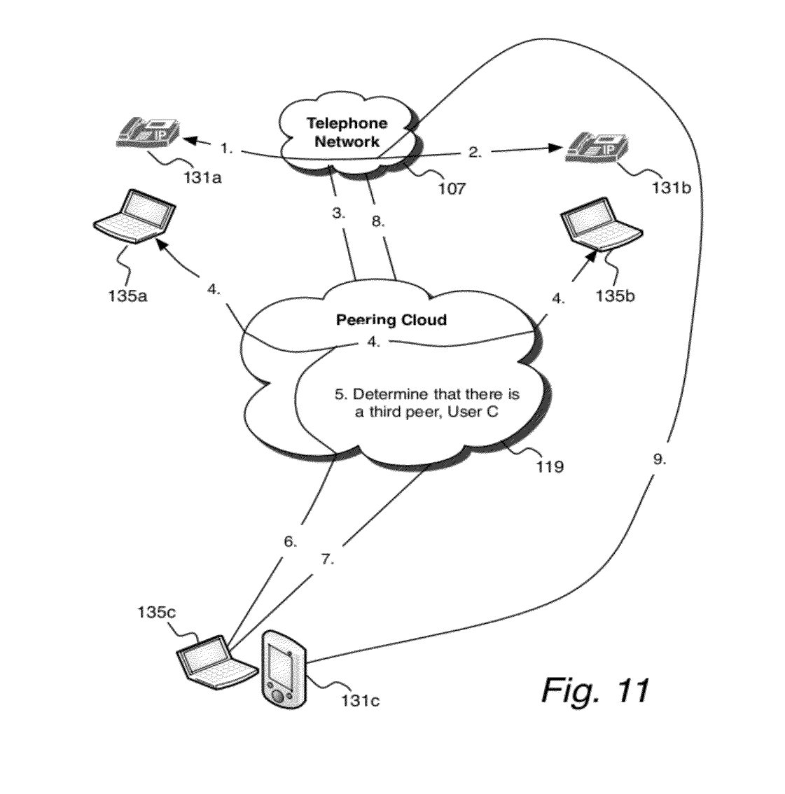

FIG. 11 is a data flow and timing sequence diagram illustrating an intervening peering session of a third user onto an existing peering session between two users. Such an intervention process includes the following steps:
1. As illustrated in previous examples, a telephone call is placed by a first user using a first telephone (Tel A) 131 a to a second user using a second telephone 131b (Tel B) via the telephone network 107. Telephones 131 could be IP phones, mobile telephones, VoIP clients, PSTN phones or any other devices used to make telephone calls.
2. The telephone network 107 places the call to the second user (Tel B) 131b.
3. The telephone network 107 transmits the call information to the peering cloud 119.
4. The peering cloud 119 establishes the peering session between peering devices 135a and 135b corresponding to the first and second user, respectively. The peering devices 135 may be, as discussed hereinabove, notebook computers, tablet computers, desktop computers, smart phones, personal digital assistants, or any other device suitable for receiving and transmitting information over a computer network.
5. The peering cloud 119 determines, by reviewing the peering group database 701, that the peering group of the first and second user includes a third user, User C.
6. The peering cloud notifies User C by transmitting an alert to the peering client executing on User C's peering device 135c that a peering session involving the peering group is taking place and inviting User C to join the peering session.
7. Through the peering client on the third user's peering device 135c, the third user indicates to the peering cloud 119 a desire to join the ongoing peering session.
8. The peering cloud places a request to conference-in the telephone 131c of User C.
9. The telephone 131c is added to the telephone call between telephones 131a and 131b.

Thus, a third peer has been added to a peering session.

The non-peering users in the peering group may also be notified of a peering session off-line, e.g., via email or by start-up alert when their peering clients are started. Such users that were off-line during a peering session may then see and access data elements in the shared data elements repository that were shared during such previous peering sessions.

In the examples provided hereinabove, peering sessions are started upon a VoIP network transmitting call information to a peering cloud 119 which determines a peering relationship between the parties to a placed call. In alternative embodiments, detection of peering relationships is performed locally by the user telephone equipment.

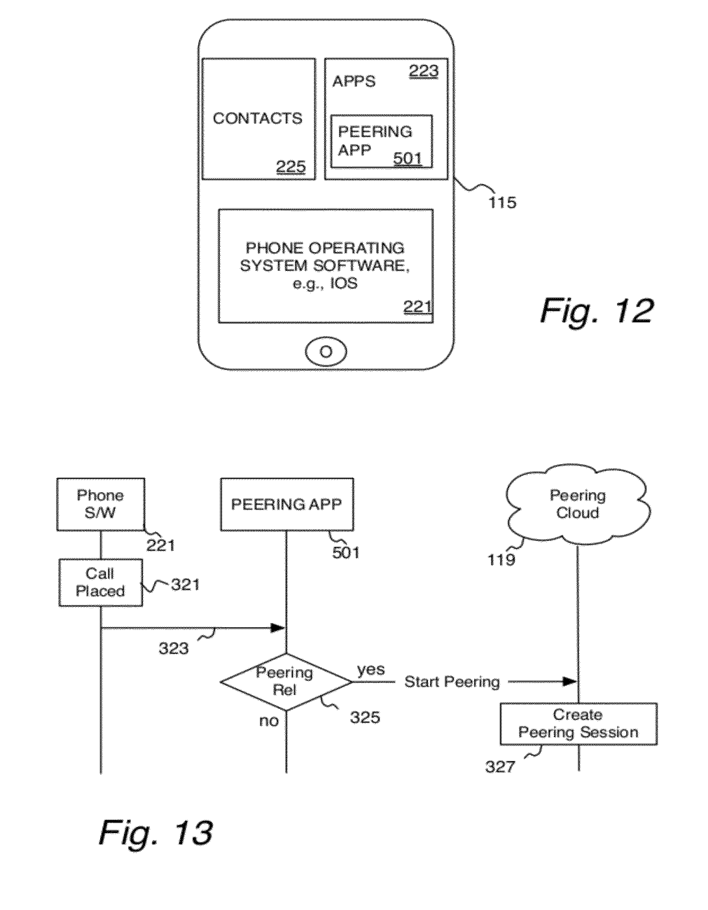

FIG. 12 is an illustration of the software installed on a smart phone 115 including the peering cloud client application. The smart phone 115 contains some telephone operating system software 221. This is deemed to include software to place telephone calls. The smart phone 115 also includes some apps 223 (i.e., application programs that perform particular tasks) including the peering cloud client app 501. The operating system software 221 and apps 223 are stored in some form of non-volatile memory, e.g., flash memory. The smart phone 115 further contains a microprocessor or microcontroller connected to the flash memory and operable to execute the instructions of the operating system software 221 and apps 223.

FIG. 13 is a timing sequence diagram illustrating the local detection of a peering relationship and initiation of a peering session on a smart phone 115, an IP phone 105b or computer 113 executing a VoIP client 111. A telephone call is placed by a user, step 321. The phone system software 221 transmits call information to the peering app 501 or the peering app 501 operates to detect that a telephone call has been placed, step 323. Alternatively, the telephone call is placed using a calling app on the smart phone, e.g., a VoIP app or a contacts database that is used for making telephone calls.

The peering client 501 maintains a contacts database 225 that includes information about peering groups to which the user belongs. The peering client 501 uses the contacts database 225 to determine whether the call is to a person with whom the user has a peering relationship, step 325. If so, a start peering message is transmitted to the peering cloud 119, step 325, and the peering cloud creates a peering session as described herein above, step 327.

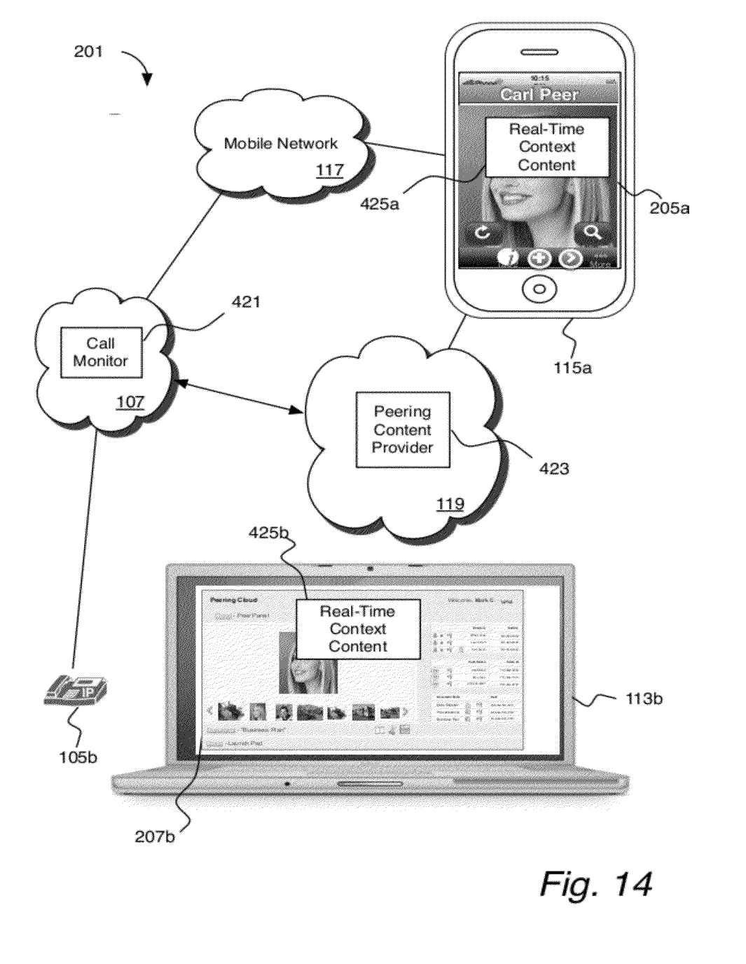

In a further alternative embodiment, the peering cloud 119 in conjunction with a telephone network component, e.g., the VoIP server 107, provides content in the peering environments 205 and 207 based on the context set by an ongoing telephone conversation. Consider for example the context of the conversation illustrated in FIG. 2 which is also replicated and expanded in FIG. 14. A call has been established between the telephone 105b and mobile telephone 115a. The voice conversation is monitored by a call monitor 421 within a telephone network 107. The call monitor 421 extracts a digital transcript from the conversation. This digital transcript is transmitted in real-time to a peering content provider 423 of the peering cloud 119. The peering content provider 423 receives the digital transcript and determines the subject matter of the conversation.

One example is a conversation between a husband and wife (the nature of the relationship of two peering cloud peers may be stored in the peering database 315) at the end of the workday. It is likely that such a conversation relates to the couple's dinner plans and may include keywords such as “restaurant,” “dinner,” or key phrases such as “where do you want to eat,” etc. These keywords, given the context in which they are spoken, may be used to discern the topic of the conversation. The peering cloud 119 uses that determined topic and other known information to display information relevant to the conversation in a window 425a and 425b in which real-time context dependent content is displayed. For example, in the example of the couple that is uttering the above-listed keywords, the peering cloud 119 may display a window of local restaurants or special offers from local restaurants.

Another use of the conversation monitoring might include the display of relevant topics to a call between an end-user and a help desk operator. When the end-user utters particular key words, those keywords may be used to discern what type of help the user is looking for and relevant topics may be displayed on the peering environment of the help desk operator.

The peering content provider 423 analyzes the parsed conversation to determine the topic of the conversation between the two or more parties to a telephone conversation that is linked to a peering session.

Bayesian Belief Networks may be particularly suitable to determine the likelihood of particular subject matter of a conversation. For example, a conversation late afternoon may be more likely to concern dinner plans than a conversation in early morning. Furthermore, a conversation between two spouses may be more likely to be about dinner plans than a conversation between a customer and a vendor. A conversation that is more likely to be about dinner plans if the keywords “dinner,” “where,” “restaurant,” or “eat” are used, whereas if the words “cartons,” “units,” or “dozen” are also used in the conversation then it would be deemed more likely to be concerning restaurant supplies between a restaurant supply store and a restaurant manager. Such conditional likelihoods may be used to build and train a Bayesian network that may be used to drive conversation-dependent or conversation-triggered information displayed in the peering environments of a peering session.

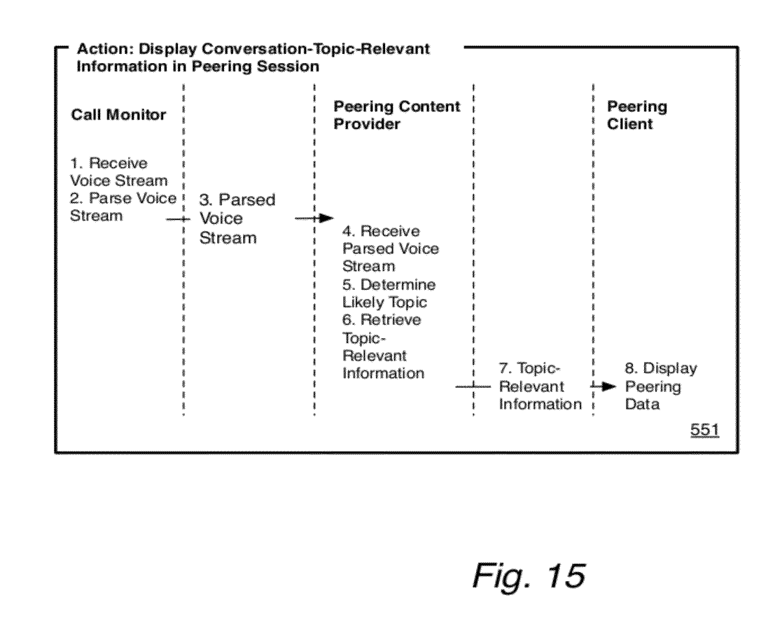

FIG. 15 is a timing sequence diagram 551 illustrating one example of use of a topic of a telephone conversation linked to a peering session to determine and display topic-relevant information in the peering environment of at least one of the users who is a party to the telephone conversation and the peering session.

The call monitor 421 monitors or snoops on the voice conversation, step 1. The call monitor 421 parses the voice stream to determine the words spoken by the parties to the telephone voice session, step 2. The parsed voice stream in the form of word tokens, for example, is transmitted to the peering content provider 423, step 3.

The peering content provider 423 receives the parsed voice stream, step 4, and uses the parsed voice stream to determine the likely topic of the conversation. As discussed above, the peering content provider 423 may combine the parsed voice stream with other known information, e.g., the relationship of the parties, time of day, location of parties, to determine the likely topic and details of the topic. One technique for combining the information is Bayesian analysis through Bayesian Belief Network.

Having determined the topic of the conversation, the peering content provider 423 determines topic-relevant information. For example, if the peering content provider has determined that the topic of conversation is dinner plans between two persons located in northwest Austin, Tex., the peering content provider may retrieve a list of local restaurants, website URL's for these restaurants and telephone numbers. This information is transmitted to the peering client 501 of at least one party to the peering and telephone sessions, step 7.

Having received the topic-relevant information, the peering client 501 displays the information in the peering environment 205 or 207. The topic-relevant information may include telephone numbers that may be used to directly create telephone calls to parties associated with the topic-relevant information, e.g., as appropriate in the example of restaurants.

From the foregoing it will be apparent that a technology has been presented herein for initiating a peering session between two or more peering devices based on a telephone call being placed between two users having a peering relationship. Such a peering session allows the two users to collaborate on shared documents and to view each other's data, e.g., photographs, word processing documents, or screen views. The peering technology presented herein provides for an elegant, quick, flexible, and automatic creation of online collaboration sessions from the placement of phone calls. This technology removes users from the tedious burden of referring collaborators to emails or online repositories of documents while allowing voice communication to proceed on what hitherto has remained most individuals' preferred mode of distance communication, namely, telephone service.

Although specific embodiments of the invention have been described and illustrated, the invention is not to be limited to the specific forms or arrangements of parts so described and illustrated. The invention is limited only by the claims.

We claim:

1. A collaboration method in which at least a first party and a second party collaborate over a voice telecommunications link and a computer network communications link, comprising:
receiving a call initiation from the first party indicating a desire to place a call to the second party;
determining whether the first party has a peering relationship with the second party;
if the first party has a peering relationship with the second party initiating a peering session between the first and second party by:
determining the peering relationship parameters of the peering relationship between the first and second party;
initiating a peering environment on a first peering device operated by the first party and initiating a peering environment on a second peering device operated by the second party based on the determined relationship parameters; and
initiating a communications link between the first and second peering environments; and
establishing a voice communications session between the first party and the second party.

2. The collaboration method of claim 1 wherein the voice communications link is established using a telephone network and the peering relationship is managed by a peering environment server, the method further comprising:
in response to receiving of a call initiation to the telephone network, transmitting a call creation message from the telephone network to the peering environment server including identifying information for the first party, corresponding to the caller, and the second party, corresponding to the callee, corresponding to the call initiation.

3. The collaboration method of claim 2 wherein the telephone network comprises a VoIP network.

4. The collaboration method of claim 2 wherein at the telephone network comprises a mobile telephony network.

5. The collaboration method of claim 1 wherein the determination of whether the first party and the second party has a peering relationship is performed by operating a calling device to transmit a call creation message to the peering environment server including identifying information for the first party, corresponding to the caller, and the second party, corresponding to the callee, corresponding to the call initiation.

6. The collaboration method of claim 5 wherein the calling device is a smart phone.

7. The collaboration method of claim 5 wherein the calling device is a computer executing a telephone client program.

8. The collaboration method of claim 1 wherein the peering relationship is managed by a peering environment server, the method further comprising:
performing the determining whether the first party has a peering relationship with the second party, in response to receiving, at the peering environment server, a call creation message from a VoIP server establishing the voice communications link including identifying information for the first party, corresponding to the caller, and the second party, corresponding to the callee, corresponding to the call initiation, by:
determining whether an entry establishing the existence of a peering relationship is present in a peering database; and
performing the initiation of a peering environment on the first peering device by transmitting from the peering environment server a peering initiation message to the first peering device.

9. The collaboration method of claim 1 wherein initiating a peering environment comprises:
launching a peering client on each of the first and second peering devices wherein the peering client displays a collaboration dashboard on each of the first and second peering devices enabling the first and second parties to simultaneously view a data item or allowing the first party to share an aspect of the first party's computing environment with the second party.

10. The collaboration method of claim 9 wherein the one or more data items is selected from the set having the members a word processing document, a spread sheet, a CAD drawing, a photograph, a desktop view, a Web page, a sound file, a video, a binary file.

11. The collaboration method of claim 9 wherein the collaboration dashboard provides at least one user interface device selected from user interface devices that include mechanisms by which a user may view and select other users with which the user has peering relationships, view and select past peering sessions with other users, and view and select one or more data items shared during past peering sessions.

12. The collaboration method of claim 1 further comprising:
receiving a peering registration request by a first user operating the first peering device;
upon receiving the peering registration from the first peering device, creating a peering profile for the first user wherein the peering profile defines at least one characteristic of the user.

13. The collaboration method of claim 12 wherein the at least one characteristic includes one or more of location, relationship status, presence, notification of activity, communication preference, client device type, date and time of client location, client system ability or characteristics.

14. The collaboration method of claim 1 further comprising:
recording data items shared between the first and second user during a peering session.

15. The collaboration method of claim 15 wherein initiating a peering session further comprises:
determining data items shared between the first and second user during prior peering sessions and displaying pointers to such shared items in a collaboration dashboard on the first and second peering environments.

16. The collaboration method of claim 1 wherein a peering relationship includes a third party, and wherein initiating a peering session between the first and second party further comprises:
notifying the third party that a peering session is being initiated between the first and second party; and
allowing the third party to join the peering session by:
creating a voice communications session between the third party and the voice communications session between the first and second party; and
joining the third party to the peering session between the first and second party by:
initiating a third peering environment on a third peering device operated by the third party; and
initiating a communications link between the third peering device and the third, first and second peering environments.

17. The collaboration method of claim 1 wherein the peering relationship parameters define user applications from which the first and second party share data by virtue of the peering relationship between the first and second party.

18. The collaboration method of claim 17 wherein the user applications include at least one application selected from social network applications, photo applications, word processing applications, contact management applications, and storage of electronic files including word processing files, audio files, application programs, smart phone apps, video files, data records, data storage.

19. The collaboration method of claim 1 further comprising:
parsing the voice communications session;
determining a topic related to the voice communications session from the parsed voice communications session;
retrieving data relevant to the determined topic related to the voice communications session; and
displaying the retrieved data relevant to the determined topic in at least one of the peering environments.

20. The collaboration method of claim 1 wherein the first and second peering devices are selected from the set including notebook computer, desktop computer, workstation computer, tablet computer, personal digital assistant, and smart phone.

21. A peering environment infrastructure, comprising one or more server computers collectively programmed:
to receive a call placement message from a voice-over-IP telephony server wherein the call placement message indicates that a voice communications session is being created between a first telephony station associated with a first user and the second telephony station associated with a second user; and
in response to receiving a call placement message to:
determine whether a peering relationship exists between the first and second user; and
upon detecting that a peering relationship exists between the first and second user, transmit a peering session start message to a peering client operated on a first peering device associated with the first user, and to transmit a peering session start message to a peering client operated on a second peering device associated with the second user.

22. The peering environment infrastructure of claim 21 further comprising:
a telephone network comprising a telephone network server operable, in response to receiving of a call initiation to the telephone network, to transmit a call creation message from the telephone network to the peering environment server including identifying information for the first party, corresponding to the caller, and the second party, corresponding to the callee, corresponding to the call initiation.

23. The peering environment infrastructure of claim 21 wherein the telephone network server is a server in a VoIP network.

24. The peering environment infrastructure of claim 21 wherein the telephone network server is a server in a mobile telephony network.

25. The peering environment infrastructure of claim 21 further comprising a calling device programmed to transmit a call creation message to the peering environment server including identifying information for the first party, corresponding to the caller, and the second party, corresponding to the callee, corresponding to the call initiation.

26. The peering environment infrastructure of claim 25 wherein the calling device is a smart phone.

27. The peering environment infrastructure of claim 25 wherein the calling device is a computer executing a telephone client program.

28. The peering environment infrastructure of claim 21 wherein the one or more servers are is further collectively programmed to:
perform the determination of whether the first party has a peering relationship with the second party, in response to receiving, at the peering server, a call creation message from a VoIP server establishing the voice communications link including identifying information for the first party, corresponding to the caller, and the second party, corresponding to the callee, corresponding to the call initiation, by:
determining whether an entry establishing the existence of a peering relationship is present in a peering database; and
perform the initiation of a peering environment on the first computer by transmitting from the peering environment server a peering initiation message to the first computer.

29. The peering environment infrastructure of claim 21 wherein the peering client of each of the first and second peering device comprises instructions to cause the first and second peering device to display a collaboration dashboard enabling the first and second parties to simultaneously view a data item or allowing the first party to share an aspect of the first party's computing environment with the second party.

30. The peering environment infrastructure of claim 29 wherein the one or more data items is selected from the set having the members a word processing document, a spread sheet, a CAD drawing, a photograph, a desktop view, a Web page, a sound file, a video, a binary file.

31. The peering environment infrastructure of claim 29 wherein the collaboration dashboard provides at least one user interface device selected from user interface devices that include mechanisms by which a user may view and select other users with which the user has peering relationships, view and select past peering sessions with other users, and view and select one or more data items shared during past peering sessions.

32. The peering environment infrastructure of claim 21 further collectively programmed to:
receive a peering registration request by a first user operating the first peering device;
upon receiving the peering registration from the first peering device, to create a peering profile for the first user wherein the peering profile defines at least one characteristic of the user.

33. The peering environment infrastructure of claim 32 wherein the at least one characteristic includes one or more of location, relationship status, presence, notification of activity, communication preference, client device type, date and time of client location, client system ability or characteristics.

34. The peering environment infrastructure of claim 21 further collectively programmed to record data items shared between the first and second user during a peering session.

35. The peering environment infrastructure of claim 34 further collectively programmed to determining data items shared between the first and second user during prior peering sessions and displaying pointers to such shared items in a collaboration dashboard on the first and second peering environments.

36. The peering environment infrastructure of claim 21 wherein at least one peering relationship includes third parties, the peering environment infrastructure further programmed to:
notify the third party that a peering session is being initiated between the first and second party; and
allow the third party to join the peering session by:
creating a voice communications session between the third party and the voice communications session between the first and second party; and
joining the third party to the peering session between the first and second party by:
initiating a third peering environment on a third peering device operated by the third party; and
initiating a communications link between the third peering device and the third, first and second peering environments.

37. The peering environment infrastructure of claim 21 wherein the peering relationship parameters define user applications from which the first and second party share data by virtue of the peering relationship between the first and second party.

38. The peering environment infrastructure of claim 37 wherein the user applications include at least one application selected from social network applications, photo applications, word processing applications, contact management applications, and storage of electronic files including word processing files, audio files, application programs, smart phone apps, video files, data records, data storage.

39. The peering environment infrastructure of claim 21 further programmed to:
parsing the voice communications session;
determine a topic related to the voice communications session from the parsed voice communications session;
retrieve data relevant to the determined topic related to the voice communications session; and
display the retrieved data relevant to the determined topic in at least one of the peering environments.

40. The peering environment infrastructure of claim 21 wherein the first and second peering devices are selected from the set including notebook computer, desktop computer, workstation computer, tablet computer, personal digital assistant, and smart phone.
